(19) United States
(12) Patent Application Publication
(10) Pub. No.: US 2026/0073467 A1
(43) Pub. Date: Mar. 12, 2026

(54) MULTI-INSTANCE GPU AWARE AUTOSCALING IN AI MODEL SERVICE

(71) Applicant: International Business Machines Corporation, Armonk, NY (US)

(72) Inventors: Abhishek Malvankar, White Plains, NY (US); Chen Wang, Chappaqua, NY (US); Yue Zhu, West Harrision, NY (US); RINA INOUE, Sumida-ku (JP); Eun Kyung LEE, Bedford Corners, NY (US)

(73) Assignee: International Business Machines Corporation, Armonk, NY (US)

(21) Appl. No.: 18/829,441

(22) Filed: Sep. 10, 2024

(51) Int. Cl. G06T 1/20

(52) U.S. Cl. CPC G06T 1/20

(57) ABSTRACT

An embodiment analyzes an inference request to determine a set of parameters of execution corresponding to the inference request. For a Large Language Model (LLM), a first amount of a computing resource is computed, that amount of computing resource being estimated to be needed to produce a set of intermediate results while processing the inference request by executing the LLM using a set of multi-instance Graphical Processing Units (GPUs) (MIGs), a MIG in the set of MIGs comprising a set of slices of a corresponding GPU (set of MIG slices). A set of instructions is sent to a controller associated with the MIG, to cause the controller to modify a second amount of the computing resource available to a MIG slice in the set of MIG slices. The inference request is scheduled to execute using the first amount of computing resource at the MIG slice.

### BACKGROUND

The present invention relates generally to the field of artificial intelligence using Large Language Models, automatic machine learning, and data science. More particularly, the present invention relates to a method, system, and computer program for multi-instance GPU aware autoscaling in AI model service.

Artificial intelligence (AI) technology has evolved significantly over the past few years. Modern AI systems are achieving human-level performance on cognitive tasks like converting speech to text, recognizing objects and images, and translating between different languages. This evolution holds promise for new and improved applications in many industries.

A Large Language Model (LLM or model, plural LLMs or models) is a type of software designed to understand and generate human-like text. LLMs are trained on massive amounts of data from books, articles, websites, and other written sources. At their core, LLMs use a neural network in a transformer architecture that has layers of interconnected nodes that process and interpret text data. An Artificial Neural Network (ANN) is a computing system made up of a number of simple, highly interconnected processing elements, which process information by their dynamic state response to external inputs. ANNs are processing devices (algorithms and/or hardware) that are loosely modeled after the neuronal structure of the mammalian cerebral cortex but on smaller scales. A large ANN implementation of an LLM might have tens of millions of interconnected nodes. By comparison, a mammalian brain has billions of neurons with a corresponding increase in the magnitude of their overall interaction and emergent behavior.

A graphical processing unit (GPU) is a specialized electronic circuit designed to accelerate the processing of images and videos for output to a display. GPUs are dedicated graphics-rendering devices used in various electronic devices, including computers, servers, workstations, game consoles, and mobile devices. Originally developed to handle the intense computational demands of rendering graphics, GPUs have since evolved to perform a wide range of tasks, particularly in parallel processing.

A GPU is typically made up of two main parts: the “die,” which is the semiconductor chip itself, and the “substrate,” which is a green circuit board that connects the die to the motherboard's electrical components. The die is mounted onto the substrate and electronically connected through “bumps” of solder that relay electrical signals between the die and the rest of the computing device. In addition to their primary function of rendering graphics, GPUs can also be used as coprocessors to support high-performance computing tasks. They may include firmware, including expansion Read-Only Memory (ROM) firmware, which can be loaded and executed by the host processor.

GPUs are primarily used to render images, animations, and video for display. This includes tasks like texture mapping, shading, and complex geometric calculations, all of which are necessary for creating realistic and detailed graphics in video games, simulations, and other visual applications. Additionally, unlike Central Processing Units (CPUs), which are optimized for sequential processing, GPUs are designed for parallel processing. This means they can handle thousands of tasks simultaneously, making them useful in processing large amounts of data quickly. Beyond graphics, GPUs are increasingly used for general-purpose computing tasks that benefit from parallel processing, such as scientific simulations, machine learning, deep learning, and cryptocurrency mining. This is referred to as General-Purpose computing on Graphics Processing Units (GPGPU).

Because of these abilities, GPUs are increasingly being used in training and running neural networks, especially LLMs and deep learning models, due to their ability to perform large-scale parallel computations. Typically, banks of GPUs are deployed for running LLMs and processing the tasks, queries, prompts, and workloads that are directed at LLMs.

An inference request in the context of an LLM refers to the process of asking the model to generate a response or prediction based on a given input. Inference is the phase where the model, having been previously trained on a large dataset, uses its learned knowledge to make predictions or provide outputs for new, unseen data. In an inference request, a user provides a specific input, such as a question, a sentence, a paragraph, or even code. This input is also commonly referred to as a “prompt” and comprises the data on which the LLM will perform an inference operation by using the LLM's neural network, which has been trained on vast amounts of training data. During this operation, the model leverages its learned patterns, relationships, and contextual understanding to generate an appropriate output. The output can be in the form of text completion, translation, summarization, code generation, or any other type of language-related task the model is capable of performing.

A model consumes time and resources to process the inference request and generate a response. Latency is the time taken by the model to generate a response after receiving an inference request. the illustrative embodiments recognize that optimizing an LLM for lower latency is crucial in applications where quick responses are needed, such as chatbots or real-time translation.

Inference requests need to be handled efficiently, especially in large-scale deployments of LLMs where many requests are processed simultaneously. The illustrative embodiments recognize that operating a model efficiently requires adequate infrastructure and resource management to manage the computational demands of the model.

### SUMMARY

The illustrative embodiments provide for multi-instance GPU aware autoscaling in AI model service. An embodiment includes analyzing an inference request to determine a set of parameters of execution corresponding to the inference request. The embodiment includes computing, for a Large Language Model (LLM), a first amount of a computing resource that will be needed to produce a set of intermediate results while processing the inference request by executing the LLM using a set of multi-instance Graphical Processing Units (GPUs) (MIGs), a MIG in the set of MIGs comprising a set of slices of a corresponding GPU (set of MIG slices). The embodiment includes causing, by sending a set of instructions to a controller associated with the MIG, the controller to modify a second amount of the computing resource available to a MIG slice in the set of MIG slices. The embodiment includes scheduling the inference request to execute using the first amount of computing resource at the MIG slice.

Other embodiments of this aspect include corresponding computer systems, apparatus, and computer programs recorded on one or more computer storage devices, each configured to perform the actions of the embodiment.

An embodiment includes a computer-usable program product. The computer-usable program product includes a computer-readable storage medium and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example configuration for MIGs-aware autoscaling in AI model service in accordance with an illustrative embodiment;

FIG. 3 depicts a block diagram of an example configuration for MIGs-aware autoscaling in AI model service in accordance with an illustrative embodiment;

FIG. 4 depicts an inefficient method of scheduling inference jobs on GPUs which can be improved in accordance with an illustrative embodiment;

FIG. 5 depicts a first improved method of scheduling inference jobs on GPUs in accordance with an illustrative embodiment;

FIG. 6 depicts a second improved method of dynamic reconfiguration of GPUs in accordance with an illustrative embodiment; and

FIG. 7 depicts a flowchart of an example process for MIGs-aware autoscaling in AI model service in accordance with an illustrative embodiment.

### DETAILED DESCRIPTION

The illustrative embodiments recognize that allocation of computing resources, such as GPUs, directly affects a model's performance parameters, such as the model's latency. However, the illustrative embodiments further recognize that simply allocating too many GPUs, while possibly improving the latency of a model, might increase a cost of operation parameter of the model.

The illustrative embodiments recognize that overallocation of computing resources to operating LLM and processing model workloads often results in underutilization of those resources. The illustrative embodiments recognize that underutilization of GPUs is undesirable for a number of reasons. For example, not only does the overallocation of GPUs for an inference request workload cause underutilization and excessive cost of processing that workload, it also increases the latency for other workloads in the queue that must await processing for a longer time due to resource unavailability from overallocation elsewhere. Overallocation also causes unnecessary wear and tear on GPUs causing a GPU to fail prematurely without having produced a sufficient return on investment. Overallocation also causes a waste of energy resource by operating more computing resource than is necessary.

Therefore, the illustrative embodiments recognize that managing GPU resources for optimal allocation is desirable. The illustrative embodiments further recognize that different workloads require different computing resources—such as GPU configurations—to run optimally, i.e., run or execute within cost, efficiency, and performance parameters that are defined as satisfactory. The illustrative embodiments further recognize that a bank of GPUs may be used for operating more than one model, and different GPU configurations may be optimal for running different models.

The illustrative embodiments further recognize that GPU utilization is affected by a variety of factors, including but not limited to varied inference request types and arrival pattern over time (e.g., day versus night), varied inference performance with different software configurations, different model configuration consuming different amount of hardware resources (e.g., GPU), unique hardware and software requirements from different models for optimal operation of those models.

A Multi-Instance GPU (MIG) is a technology that allows a single physical GPU to be partitioned into multiple smaller, isolated instances, each with its own dedicated resources like memory, cores, and bandwidth. This enables multiple users or processes to run workloads simultaneously on a single GPU, as if they were running on separate GPUs.

A MIG can split a GPU into several independent instances. An instance of a GPU created in this manner is also interchangeably referred to herein as a slice, a MIG slice, a partition, a segment, or a division of a GPU. For example, an example GPU can be divided into up to seven instances, each functioning as a separate GPU with dedicated resources. These instances can vary in size and capability, depending on the workload requirements. Generally, a GPU SM slice (GPU Streaming Multiprocessor slice) is the smallest fraction of the SMs (Streaming Multiprocessor) available on the GPU. In a presently available GPU architecture, a GPU SM slice is roughly one seventh of the total number of SMs available in the GPU when configured in MIG mode. This could change in the future with the evolution of the GPU architecture. A GPU memory slice is the smallest fraction of the GPU's memory, including the corresponding memory controllers and cache. In a presently available GPU architecture, a GPU memory slice is roughly one-eighth of the total GPU memory resources, including both capacity and bandwidth. This could change in the future with the evolution of the GPU architecture.

A MIG slice is distinct from a GPU SM slice (GPU Streaming Multiprocessor slice) or a GPU memory slice. A GPU slice is one GPU SM slice and one GPU memory slice. A MIG slice can be configured with one or more GPU SM slices and one or more GPU memory slices in a configuration that does not map directly to one or more GPU slices. For example, a MIG slice could have the processor resource equivalent of two GPU SM slices but the memory resource equivalent of four GPU memory slices. A MIG slice, therefore, is simply some combination of GPU SM slice(s) and GPU memory slices(s).

In a MIG, typically, each GPU instance operates in isolation from the others, meaning that workloads running on one instance do not interfere with those on another. This is generally enabled for security and stability, particularly in multi-tenant environments like cloud computing, where different users or organizations may share the same physical GPU.

In a MIG configuration, the single physical GPU's resources, including compute cores, memory, and bandwidth, are divided among the instances. MIG technology provides flexibility in managing workloads. For example, an organization could allocate smaller instances to developers for testing and debugging, while reserving larger instances for production workloads or intensive computations. The illustrative embodiments recognize that merely sizing an instance large or small in this manner is insufficient for preventing or minimizing overallocation of an instance and the resulting underutilization of the instance.

By enabling multiple instances on a single GPU, MIG allows for using a single physical GPU for processing multiple simultaneous workloads. While MIG technology aims to increase the throughput of a single GPU, the illustrative embodiments recognize that MIG capability alone is insufficient for appropriate GPU allocation for workloads according to workload demands, model demands, or both, in a dynamically changing computing environment. The illustrative embodiments recognize that although MIG slice size has a big impact on models'latency, some models are not very sensitive to the size of the MIG slice. The illustrative embodiments further recognize that the MIG slice delivering the shortest latency is not always the most energy and/or resource-efficient. Therefore, optimal allocation of GPU resources—i.e., an allocation that causes the GPU resource to run or operate within cost, efficiency, and performance parameters that are defined as satisfactory—is a difficult problem. “Optimal” value of a parameter as used herein means a value of the corresponding parameter that is defined to be satisfactory, or within a tolerance of a threshold for that value.

The illustrative embodiments address the deficiencies described herein and provide a process (as well as a system, method, and computer program product embodied in a machine-readable medium) for MIGs-aware autoscaling in AI model service. An embodiment can be used in conjunction with or as a substitute for an existing method for GPU management. The illustrative embodiments utilize techniques described herein for the MIGs-aware autoscaling in AI model service using MIGs. A MIG, when configured to operate in conjunction with an embodiment in a manner described herein, provides an improved manner of GPU operation for the benefits and advantages, as described herein.

An embodiment is configured to operate with a model that is of the transformer type. A transformer type model includes a layer known as an Attention Layer.

An Attention Layer in a Large Language Model is a specific layer in the model's neural network that allows the model to focus on different parts of the input data when generating an output. The attention layer helps the model determine which words or tokens in an input text are most relevant to the current task, enabling the model to effectively capture contextual relationships between token. The attention mechanism of an attention layer assigns different weights to different parts of the input data. This weighting helps the model “attend” to specific words or tokens that are relatively more important for generating good contextual output, rather than treating all words equally. By focusing on certain parts of the input based on relevance, the attention layer helps the model understand the context of the input better. For example, in a sentence with multiple clauses, the attention layer can help the model determine which clause is more relevant to the task at hand. A specific type of attention mechanism used in transformers-based LLMs is self-attention (or scaled dot-product attention). Self-attention allows the model to weigh the importance of each word relative to every other word in the same sequence. Self-attention is particularly useful for capturing dependencies between words, even if the words are far apart in the sentence. For example, in a sentence like “The cat that sat on the mat was brown,” when predicting the word “brown,” the attention layer might focus on “cat” and “mat”to determine what “was brown”refers to, rather than focusing on less relevant words.

An attention layer works by using a QKV structure. Query (Q) represents the current word or token for which the model is trying to find relevant information. Key (K) represents potential “matches” for the query from all the words in the sequence. Value (V) represents the actual information that is retrieved when a query matches a key. The attention mechanism computes a score between the query and each key, and then uses these scores to weigh the corresponding values. The output is a weighted sum of the values, which emphasizes the most relevant information.

The attention layer can use two types of attention. Scaled Dot-Product Attention and Multi-Head Attention. In scaled dot-product attention, the attention score is computed using the dot product of the query and key vectors. The scores are then scaled and passed through a softmax function to convert them into probabilities, which sum to 1. These probabilities are used to weight the values, producing the final output of the attention layer. In multi-head attention, instead of computing a single set of attention scores, the model uses multiple attention “heads,” each with different parameters. Each head focuses on different aspects of the input data, capturing diverse types of relationships. The outputs of all heads are concatenated and processed further to produce the final output.

An attention layer is a specific and important component in LLMs. Attention layers allow the model to better understand the context by focusing on the most relevant parts of the input. This leads to improved contextuality in LLMs by producing more coherent and contextually appropriate responses. Furthermore, an attention layer enables the model tin handling long-range dependencies. Self-attention can capture dependencies between words that are far apart in the text, which is a significant advantage over earlier models like RNNs (Recurrent Neural Networks), which struggled with long-range dependencies. Lastly, attention layers are computationally efficient and can be parallelized, making them very scalable and well-suited for large-scale models.

The attention layer is an intermediate layer in a model's neural network and is configured with a set of nodes that receive inputs from a previous layer in the model's neural network. The attention layer nodes perform certain computations on those inputs and produce a set of intermediate results. The set of intermediate results forms an input to a subsequent layer in the neural network of the model.

The illustrative embodiments recognize that the intermediate results, which take the form of Key-Value (KV) pairs, are an important indicator of the computational resource requirement of the model when processing certain inputs. In other words, the illustrative embodiments recognize that given an input, and determining the memory footprint of the cache area needed to store the corresponding intermediate output—set of KVs—of the attention layer, it is possible to estimate the computational resources to allocate to the model for efficient execution of the model, such as in sizing the memory allocated to a slice(s) in the MIG bank where the model will run. Within the scope of the illustrative embodiments, any memory available to a GPU—whether in the form of cache memory or another type of memory or a combination thereof—may be referred to as KV cache memory so long as that memory is used for storing KV pairs, (a reference to KV cache herein is a reference to a collection of KV pairs, not necessarily the cache type of memory).

Accordingly, an embodiment receives an inference request that will be processed by a transformer-type model. In one embodiment, the request is an actual request from a user or system. In another embodiment, the request is a hypothetical or test request constructed for the purposes of the embodiment. The request may have associated therewith a set of parameters of execution. Parameters of execution include information about the model with which to execute the workload, the parameters describing the workload, the optimal performance and efficiency parameter values that have to be achieved during the execution, or some combination thereof.

The computing environment where the model is expected to run has a set of parameters of the environment. The parameters of environment include but are not limited to-number of users presenting requests at the time the workload is received, request rate (number of requests per second) being received in the environment, input token length, output token length, model configuration, GPU or MIG types, inference server type (e.g., vLLM, TGIS). The described examples of the parameters of execution and parameters of the environment are not intended to be limiting on the illustrative embodiments. Those of ordinary skill in the art will be able to think of many other similarly purposed parameters and the same are contemplated within the scope of the illustrative embodiments.

The embodiment selects an LLM that will be used to process the request. the embodiment estimates a size of the intermediate results set that is likely to be produced by the attention layer of the selected model when processing the request.

In one embodiment, the size of the intermediate results set that is likely to be produced is estimated using historical performances of that model. That is, the embodiment retrieves from a historical database of model performance those records where the model has processed similar requests. In one case, the similar request is identified in the database according to a number and distance of the tokens in the request. an exact match need not be found or available in the database. A nearest match algorithm can be used to identify the closest match and the corresponding record extracted. Using the selected record(s) from the historical model performance database, the embodiment determines the size of the KV output of the attention layer. The embodiment uses the determined size of the KV output and extrapolates—without executing the received request on the model—an estimated size of the KV output of the attention layer of the model when the received request will be processed.

In another embodiment, the size of the intermediate results set that is likely to be produced is estimated using a heuristic corresponding to that model. That is, the embodiment computes, using a heuristic or algorithm and the number of nodes in the attention layer as an input to the heuristic, an estimate of the size of memory footprint of the KV output of the attention layer of the model.

In another example embodiment, the estimate of the memory footprint of the intermediate results set of the attention layer is made not only based on the request and the memory size estimation method but also by using a set of parameters of environment existing in the environment where the model will execute to process the request. In one embodiment, a value in the set of parameters of environment is an estimate—again based on historical data or a heuristic. In another embodiment, a value in the set of parameters of environment is an actual value observed in the environment at or near the time when the model is to process the request.

In another example embodiment, the estimate of the memory footprint of the intermediate results set of the attention layer is made not only based on the request and the memory size estimation method but also by using a set of parameters of execution associated with the request. In one embodiment, a value in the set of parameters of execution is an estimate—again based on historical data or a heuristic. In another embodiment, a value in the set of parameters of execution is an actual value associated with the request.

In another example embodiment, the estimate of the memory footprint of the intermediate results set of the attention layer is made not only based on the request and the memory size estimation method but also by using a combination of one or more parameters of execution and parameters of environment in a manner described herein. These methods of estimation of memory size and/or parameter values are described only as non-limiting examples. From these examples and the description of the embodiments, other ways for these estimations will be apparent to those of ordinary skill in the art and the same are contemplated within the scope of the illustrative embodiments. Furthermore, the described examples of the conditions or factors are not intended to be limiting on the illustrative embodiments. Those of ordinary skill in the art will be able to envision many other conditions or factors that influence the optimization of GPU allocation in a MIGs environment and the same are contemplated within the scope of the illustrative embodiments.

Using the estimated memory size, an embodiment constructs a set of instructions for a controller of a MIG. The set of instructions instruct the controller to allocate the estimated size of the memory—for example, but not limited to, cache memory—to a slice that will be utilized for processing the request on the model. In response to the set of instructions, the controller allocates to the slice the appropriate type of memory that is suitable for storing the intermediate results from the attention layer. The model then uses the slice with the allocated memory to process the request.

In one embodiment, the slice may already have some allocated memory of the type but less than the estimated size. In such a case, the controller allocates additional memory of the type to form the allocated memory of the type and estimated size. In another embodiment, the slice may already have some allocated memory of the type but more than the estimated size. In such a case, the controller deallocates some memory of the type from the slice to form the allocated memory of the type and estimated size.

In one embodiment, the controller is an improved software, hardware, or firmware component. This improved component is operable to configure one or more instances in one or more MIGs. Such a component is interchangeably referred to herein as a MIG management component or a resource manager, and may include a driver or interface with a driver. A type of driver is presently available that is capable of configuring and reconfiguring instances within a MIG. Such drivers are known as Dynamic Resource Allocation (DRA) drivers.

The set of instructions from the embodiment instructs the MIG management component, such as the DRA for the corresponding MIG, to configure one or more instances within the MIG(s) according to a set of configuration parameters, including but not limited to the estimated memory size. The MIG management component configures the requested instances according to the configuration parameters, and makes the configured instances available for executing the workload on the model.

Another embodiment monitors the performance of the workload together with monitoring the computing environment while the workload is executing at the configured instances. The embodiment detects a change in the environment, the performance of the workload, or both. Some examples of the changes in the environment include but are not limited to—other workloads entering and leaving the environment, hardware changes in the environment, software changes in the environment, change in energy usage or restriction in the environment, and other changes normally observed in a computing environment.

Responsive to the change in the performance of the workload, the change in the environment, or both, the embodiment triggers a reconfiguration of the MIG instances. The reconfiguration operation re-estimates the size of the memory for storing the intermediate results taking into account the change in a manner described herein. The embodiment constructs a new set of instructions to reconfigure the same or different instances that are executing the workload. The embodiment causes the workload to utilize the new configuration and continue to completion. In one embodiment, the workload execution suspends or pauses on the old configuration and the execution resumes on the reconfigured instances. In another embodiment, the workload execution ends on the old configuration and restarts on the reconfigured instances.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting on the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

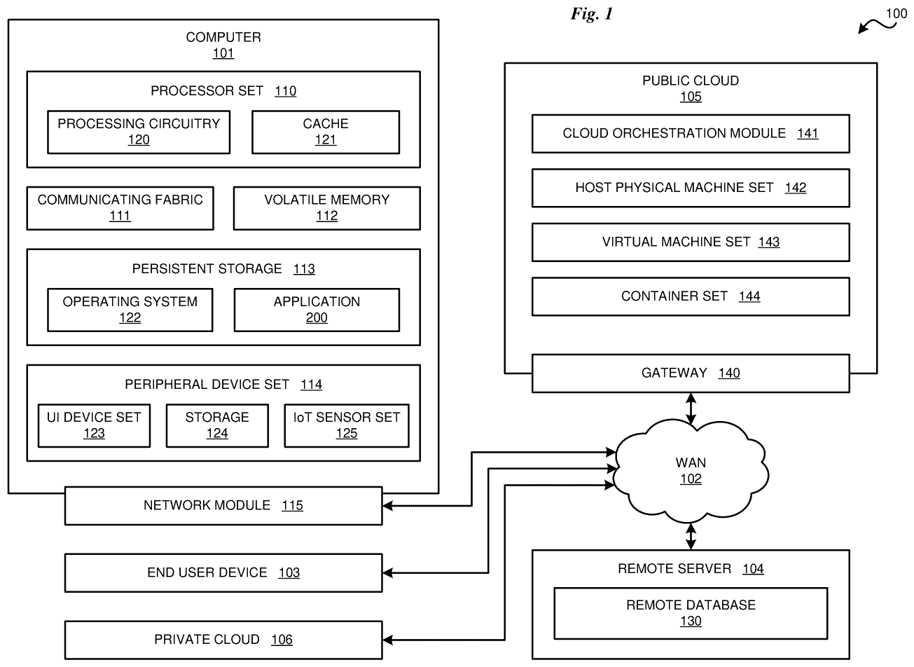

With reference to FIG. 1, this figure depicts a block diagram of a computing environment 100. Computing environment 100 contains an example of an environment for the execution of at least some of the computer code involved in performing the inventive methods, such as application 200 that implements one or more embodiments for MIGs-aware autoscaling in AI model service as described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

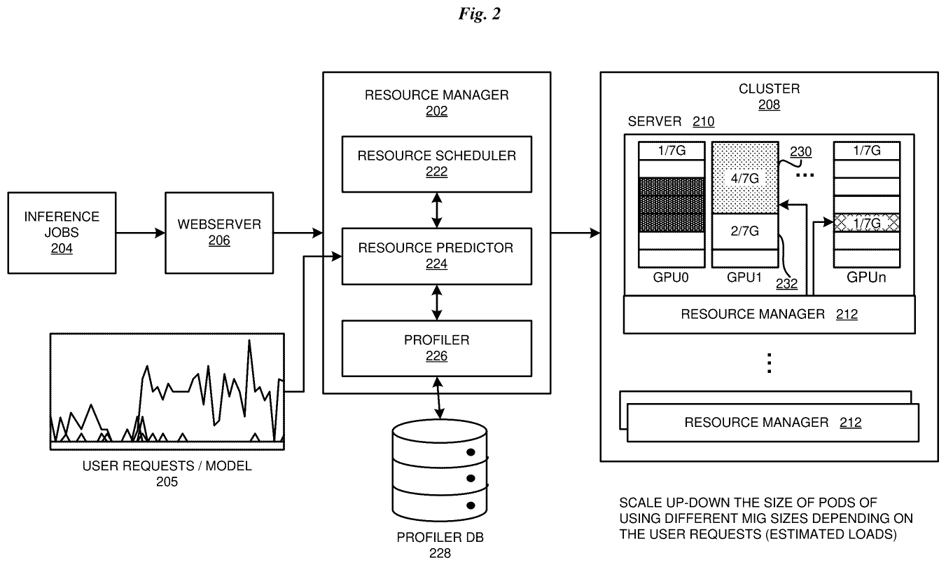

With reference to FIG. 2, this figure depicts a block diagram of an example configuration for MIGs-aware autoscaling in AI model service in accordance with an illustrative embodiment. Resource manager 202 is an example of application 200 in FIG. 1.

One or more inference requests, or inference jobs 204 are received into the computing environment, e.g., into job queue 206, for processing by one or more models executing using cluster 208 in the computing environment. Cluster 208 comprises one or more servers 210, a server 210 comprising a bank of GPUs, GPU0, GPU1 . . . GPUn. In one embodiment, some GPUs in the bank are MIGs. In another embodiment, all GPUs in the bank are MIGs.

In the depicted example configuration, one or more DRA drivers 212 manage the GPUs in the bank, sometimes via a backend interface. DRA drivers 212 manage the configuration of resources for one or more instances at MIGs in the bank of GPUs, as described herein. Differently shaded slices in GPU0-GPUn represent differently configured instances. Some example slice allocations are depicted, such as three shaded slices in GPU0 may have been assigned separately to different tasks/models/executions, or together to one task/model/execution. Slice 1/7G in GPU0, slice 4/7G in GPU1 (230), slice 2/7G in GPU1 (232), and 1/7G in GPUn may be assigned in a similar manner.

Resource manager 202, according to one embodiment, includes resource scheduler 222. Resource scheduler 222 schedules inference jobs 204 from queue 206 to execute on cluster 208 using a combination of slices in GPUs GPU0-GPUn.

Component 224 implements a resource prediction and dynamic instance resizing function in the manner of an embodiment described herein. Component 224 interfaces with a MIG controller—e.g., DRA driver(s) 212—depending on a particular MIG implementation, to configure and reconfigure a slice in a GPU in the GPU bank within cluster 208. Specifically, component 224 communicates with scheduler 222 to determine an optimal memory sizing configuration of a combination of MIG instances for an inference job that scheduler 222 is about to schedule for execution.

Using the memory size estimated in a manner described herein, component 224 constructs and sends a set of instructions to driver 212 to cause a reconfiguration of a subset of slices within one or more MIGs in the bank such that the reconfigured subset of slices will provide the estimated memory size to hold the intermediate results of the attention layer when the selected model processes the particular workload using the subset of slices. For example, component 224 constructs and sends a set of instructions to driver 212 to cause a reconfiguration of a subset of slices within one or more GPUs in the bank. For example, in one example case, GPU1 may have a configuration of seven slices equally dividing the total available memory in GPU1, but as a result of the set of instructions, slice 230 is formed in GPU1 where slice 230 has four times the default slice memory that GPU1 assigns to a slice. In another example case, slice 230 and 232 may each have been sized with 3/7^{th} of total memory of GPU1 prior to the set of instructions, but as a result of the set of instructions, slice 232 may be reduced to 2/7^{th} of the total memory and the 1/7^{th} memory that is deallocated from slice 232 is allocated to slice 230 to increase the memory at slice 230 to 4/7^{th} of the total memory available at GPU1.

In one embodiment, a slice configuration profile for a given workload and model might be available in profiler database 228 that is maintained by profiler component 226. Component 224 communicates with profiler component 226 to select one or more profiles from profile database 228 that match the given workload and model, and modifies or updates the profile with the estimated memory size for the workload and model combination in a manner described herein. Using the modified profile, component 224 constructs and sends a set of instructions to driver 212 to cause a reconfiguration of a subset of slices within one or more MIGs in the bank.

For example, assume slice 228 has been previously configured with a certain amount of memory—say x GB—within GPU1. Component 224 determines that the future inference job A to be scheduled would optimally run on slice 230 if slice 228 is reconfigured with x+y GB of memory. Accordingly, component 224 creates and sends a set of instructions for DRA driver 212 to cause slice 230 to be reconfigured with an increased memory allocation of x+y GB within MIG GPU1 to optimally execute inference job A. Further assume that another future inference job B after job A should run on slice 232 but does not need m GB of memory. Accordingly, component 224 creates and sends a different set of instructions for DRA driver 212 to cause slice 232 to be reconfigured with a reduced memory allocation m-n GB within MIG GPU1 to optimally execute inference job B.

Further assume that job C is presently executing using slice 230 where slice 230 has been configured with p GB of memory for the optimal execution of job C. Component 224 detects a change in cluster 208—the change being any type of change examples described herein and contemplated within the scope of the illustrative embodiments. While job C is executing using slice 230, component 224 creates and sends a different set of instructions for DRA driver 212 to cause slice 230 to be reconfigured such that the memory allocation of slice 230 increases to p+q GB (or reduces to p-q GB, as the case may be) within MIG GPU1 to continue to optimally execute inference job C. The reconfiguration of slice 230 is dynamic, i.e., during the execution of job C on slice 230, in a manner described herein.

Any slice in any MIB within the GPU bank of any server 210 within any cluster 208 can be reconfigured by resource manager 202 in this manner. Any job in queue 206 may cause a reconfiguration. Any change within cluster 208 or queue 206 may cause a dynamic reconfiguration.

In one embodiment, component 224 monitors the performance of a job, e.g., job C in the example above, while the job executes on a slice, e.g., on slice 230. Component 224 can trigger a dynamic reconfiguration of slice 230 in a similar manner to change a performance parameter of the executing job on the slice.

In one embodiment, profiler 226 operates to construct one or more profiles for storage in profile database 228. For example, profiler 226 may use a benchmark load execution on a selected model to construct and store a profile in profile database 228.

In one embodiment, combination 205—comprising an inference request and a model specification on which to run the request—may be a test case, created by a tester, a test environment, a heuristic, or an algorithm. In a manner described herein, component 224 uses combination 205 to estimate a memory requirement for the optimal execution of the request of combination 205 using the model of combination 205 in cluster 208. Such testing using combination 205 can be useful in determining and improving the accuracy of the memory estimation process.

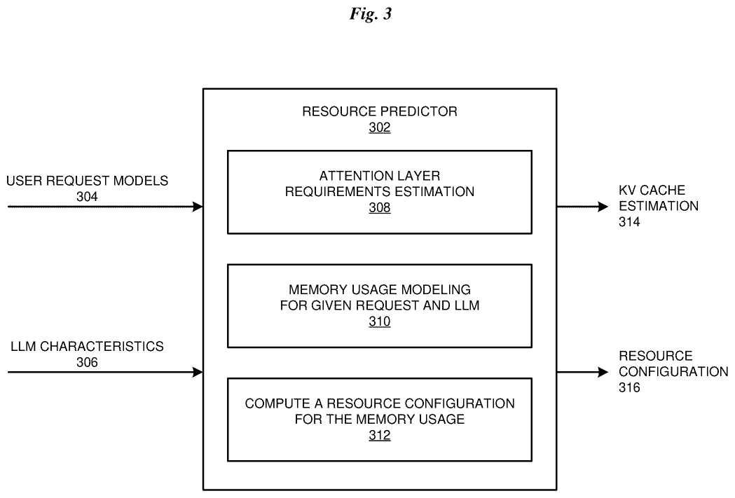

With reference to FIG. 3, this figure depicts a block diagram of an example configuration for MIGs-aware autoscaling in AI model service in accordance with an illustrative embodiment. Resource predictor 302 can be implemented as component 224 in FIG. 2.

Input 304 includes a request and model combination, e.g., an inference request and a transformer-type model on which to process the inference request. input 306 includes one or more characteristics of the model identified in input 304. For example, input 306 may come from a repository and may include a number of nodes in an attention layer of the model identified in input 304.

Subcomponent 308 performs the requirements estimation on the attention layer of the model generally. Specifically, subcomponent 308 estimates an amount of memory that the attention layer of the model might need to output and store the intermediate results generally. For example, in one embodiment, the intermediate results may be a set of KV pairs, and the memory where the pairs are stored might be of the type—cache memory. In another embodiment, the KV cache may be stored in a GPU memory that is not designated as cache memory, such as a primary memory of the GPU. Thus, in this example, subcomponent 308 performs KV cache estimation.

Using the estimation produced form subcomponent 308, subcomponent 310 estimates the memory requirement as pertains to processing the request in input 304 on the model of input 304. Specifically, subcomponent 310 estimates an amount 314 of memory that the attention layer of the model might need to output and store the intermediate results when the specific request is processed on the specific model, given the specific parameters of execution and parameters of environment. for example, the intermediate results may be a set of KV pairs, and the memory where the pairs are stored might be of any suitable type as described earlier. Thus, in this example, subcomponent 310 performs an adjusted or specific KV cache estimation to produce output 314—which would be a KV cache estimate in this example—given the estimation from subcomponent 308, the conditions existing in one or more MIG slices, MIGs, the server, or the cluster as a whole, and any specific parameters of execution.

Subcomponent 312 uses the adjusted or specific memory requirement output 314 of subcomponent 310 and composes a set of instructions for a MIG controller. The set of instructions comprise resource configuration 316 which includes the adjusted or specific memory estimate that the controller should configure in one or more slices in one or more MIGs.

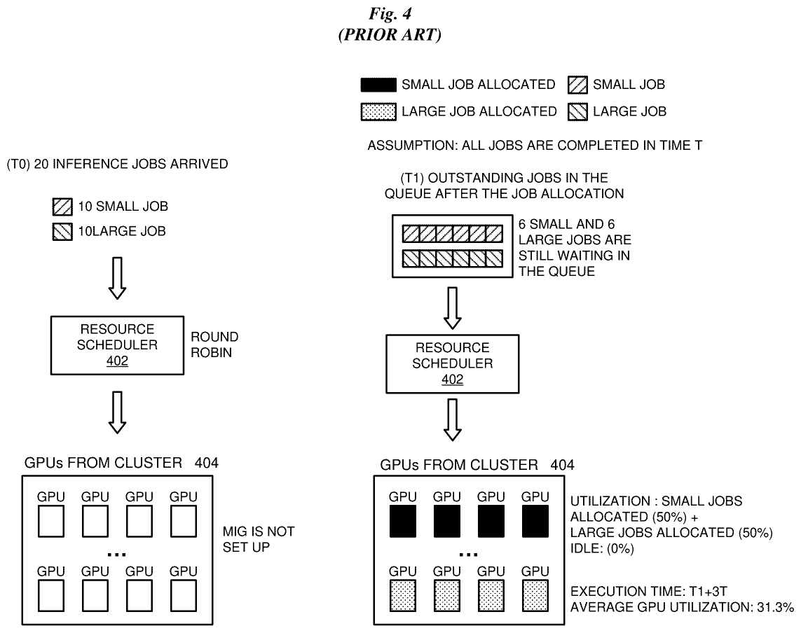

With reference to FIG. 4, this figure depicts an inefficient method of scheduling inference jobs on GPUs which can be improved in accordance with an illustrative embodiment. Resource scheduler 402 is a prior-art resource scheduler that has not been improved with an embodiment. Resource scheduler 402 manages bank 404 of GPUs in a cluster where MIG has not been set up for the GPUs. In other words, the entirety of one or more GPUs is allocated to a job by scheduler 402.

In the depicted inefficient example, assume that at time T0, 20 inference jobs arrive in a queue. Of the 20 jobs, 10 are small jobs, i.e., jobs that require smaller than a threshold amount of GPU resources, and 10 are large jobs, i.e., jobs that require greater than or equal to the threshold amount of GPU resources. Assume that in the depicted inefficient example, half the GPU resources are statically committed to executing small jobs, and the remaining half of the GPU resources are committed to executing large jobs. At time T1, scheduler 402 is able to schedule 4 small jobs and 4 large jobs from the queue, thus occupying all GPU resources. 6 small and 6 large jobs remain in the queue. Assume that each job takes T time to complete and there is no idle time between consecutive scheduling. Thus, the first schedule of 4 small and 4 large jobs completes in T time, the second schedule of 4 small and 4 large jobs completes in the next T time, and the schedule of remaining 2 small and 2 large jobs completes in a third T time. The total execution of 10 small and 10 large jobs takes T1+3T time with an average GPU utilization of approximately only 31.3%. as can be seen, this manner of using GPU resources undesirably underutilizes the GPU resources while the GPU resources consume an amount of energy that is not significantly different from what they would consume when fully utilized.

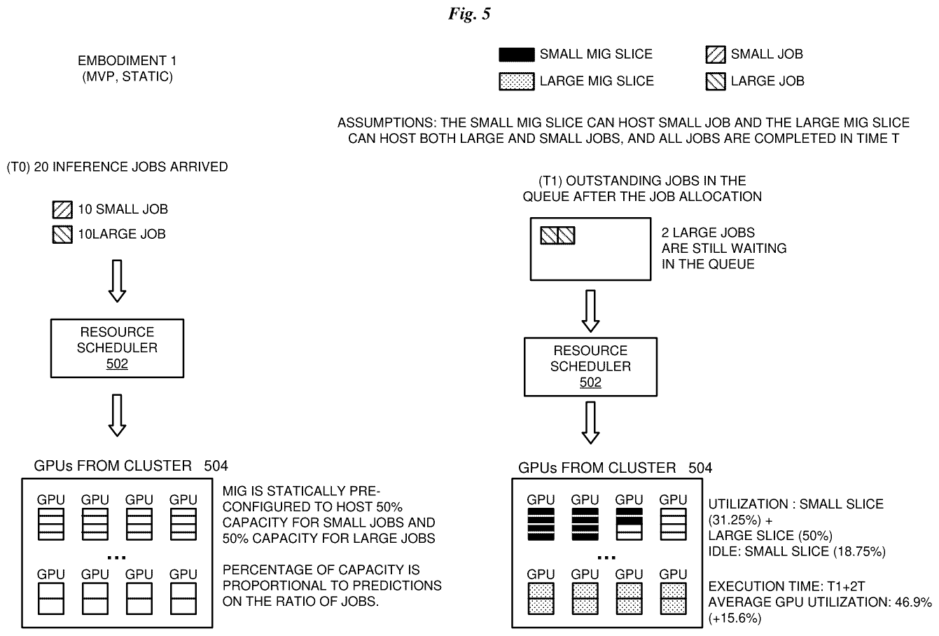

With reference to FIG. 5, this figure depicts a first improved method of scheduling inference jobs on GPUs in accordance with an illustrative embodiment. Resource scheduler 502 is an improved resource scheduler in accordance with an embodiment. Resource scheduler 502 manages bank 504 of GPUs in a cluster where MIG has been set up for the GPUs. In other words, one or more slices of one or more GPUs can be allocated to a job by scheduler 502.

In the depicted example, some limitations of the infrastructure still exist, e.g., the depicted MIG set up allows creating slices or instances within a GPU but the slices are preconfigured—i.e., once a slice is configured with some of the GPU resources, that configuration is static while the GPU is online and cannot be changed without unloading all jobs from the GPU and taking the GPU offline for reconfiguration. Some data centers have GPU banks that are limited in this manner and are expected to continue operations using these banks for the foreseeable future. Therefore, the embodiment in the partially improved resource scheduler 502 is contemplated for at least some improvement in such computing environments.

In the operation depicted in this figure, the utilization improves over the example of FIG. 4. Assume that it is expected that of the jobs that are received during the up-time of the GPUs, half will be small jobs and half will be large jobs. Accordingly, in the depicted partially efficient example, half the GPU resources are statically preconfigured into smaller than threshold size slices to execute small jobs, and the remaining half of the GPU resources are preconfigured into comparatively larger slices for executing large jobs. The preconfigured small slices may be all sized the same within a GPU or may be sized differently while remaining below the threshold size within a GPU, the preconfigured large slices may be all sized the same within a GPU or may be sized differently while remaining at or above the threshold size within a GPU, and different GPUs in the MIG set up may be configured differently in this manner.

Again, assume that at time T0, 20 inference jobs arrive in a queue. Of the 20 jobs, 10 are small jobs—each serviceable with one small MIG instance, and 10 are large jobs—each serviceable with one large MIG instance. 4 GPUs are each configured with 4 small slices, and 4 GPUs are each configured with 2 large slices, as shown. Assume that each job takes T time to complete and there is no idle time between consecutive scheduling.

At time T1, improved scheduler 502 selects a small slice from available 16 small slices for each of the 10 small jobs and is able to schedule all 10 small jobs to run and complete within time T. 8 large slices are available, so improved scheduler 502 is able to schedule 8 out of the 10 large jobs to run and complete within time T, and 2 large jobs remain in the queue. Thus, the first schedule of 10 small and 8 large jobs completes in T time, the second schedule of 2 remaining large jobs completes in the next T time. The total execution of 10 small and 10 large jobs takes T1+2T time with an average GPU utilization of approximately 46.9%, an improvement of approximately 15.6% over the disadvantageous operation of FIG. 4. This manner of using GPU resources is desirable in legacy GPU infrastructure where MIG set up only allows for static preconfiguration of the slices.

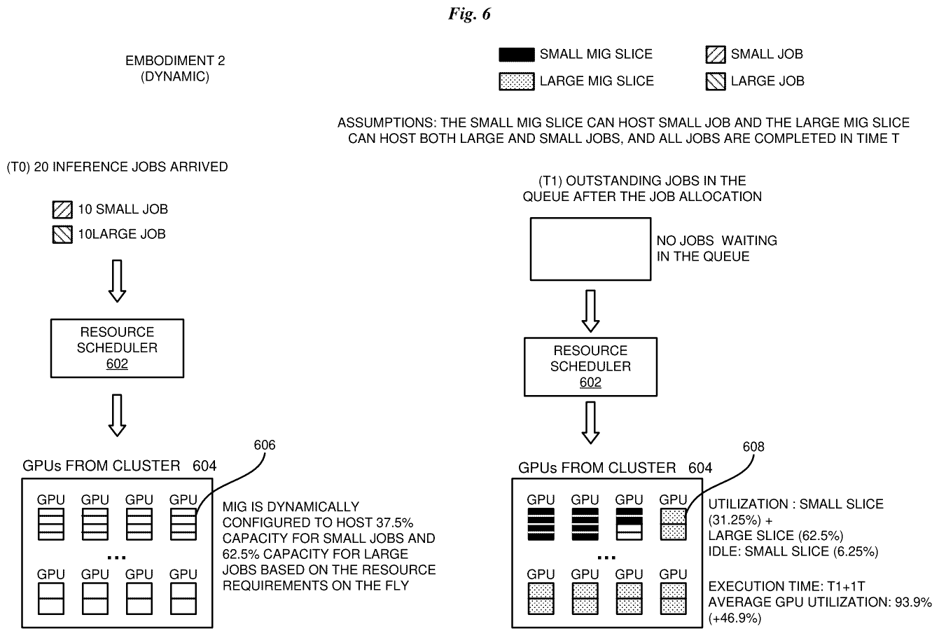

With reference to FIG. 6, this figure depicts a second improved method of dynamic reconfiguration of GPUs in accordance with an illustrative embodiment. Resource scheduler 602 is an improved resource scheduler in accordance with an embodiment. Resource scheduler 602 manages bank 604 of GPUs in a cluster where MIG has been set up for the GPUs. In other words, one or more slices of one or more GPUs can be allocated to a job by scheduler 602.

In the depicted example, the MIG setup allows creating slices or instances within a GPU and the slices can be reconfigured—i.e., once a slice is configured with some of the GPU resources, that configuration is changeable while the GPU is online without unloading currently executing jobs from the GPU and without taking the GPU offline for reconfiguration. Modern MIG-enabled GPU banks have the dynamic reconfiguration capability but no ability to look into the job or model characteristics and determine when a reconfiguration might be needed or how to reconfigure to achieve a desired performance metric, e.g., an optimal parameters of execution or an optimal parameters of environment. An embodiment implemented in resource scheduler 602 imparts these missing functions to dynamically configurable MIGs.

In the operation depicted in this figure, the utilization further improves over the example of FIG. 5. Assume the same example scenario—that it is expected that of the jobs that are received during the up-time of the GPUs, half will be small jobs and half will be large jobs. Accordingly, in the depicted example, half the GPU resources are initially preconfigured into smaller than threshold size slices to execute small jobs, and the remaining half of the GPU resources are initially preconfigured into comparatively larger slices for executing large jobs. The preconfigured small slices may be all sized the same within a GPU or may be sized differently while remaining below the threshold size within a GPU, the preconfigured large slices may be all sized the same within a GPU or may be sized differently while remaining at or above the threshold size within a GPU, and different GPUs in the MIG set up may be configured differently in this manner.

Again, assume that at time T0, 20 inference jobs arrive in a queue. Of the 20 jobs, 10 are small jobs—each serviceable with one small MIG instance, and 10 are large jobs—each serviceable with one large MIG instance. 4 GPUs are each configured with 4 small slices, and 4 GPUs are each configured with 2 large slices, as shown. GPU 606, for example, is configured with 4 small slices. Assume that each job takes T time to complete and there is no idle time between consecutive scheduling.

At time T1, improved scheduler 602 selects a small slice from available 16 small slices for each of the 10 small jobs and is able to schedule all 10 small jobs to run and complete within time T. 4 small slices from two of the GPUs and 2 small slices from another small sliced GPU are used in this manner, leaving 2 small slices in the third GPU as well as all 4 slices in the fourth GPU 606 unused. 8 large slices are available, so improved scheduler 602 is able to schedule 8 out of the 10 large jobs to run and complete within time T using the four large-sliced GPUs. 2 large jobs remain to be scheduled, so improved resource scheduler 602 performs a dynamic reconfiguration of small-sliced GPU 606 to create large-sliced GPU 608 as shown. Scheduler 602 schedules the remaining 2 large jobs using the large slices from GPU 608.

Thus, all 10 small and 10 large jobs completes in T time, leaving only 2 small slices unutilized. The total execution of 10 small and 10 large jobs takes T1+T time with an average GPU utilization of approximately 93.9%, an improvement of approximately 46.9% over the utilization in the operation of FIG. 5. Because the total time to run the job has reduced, the total energy consumption will also be proportionally reduced along with the corresponding increase in the utilization of the GPU resources.

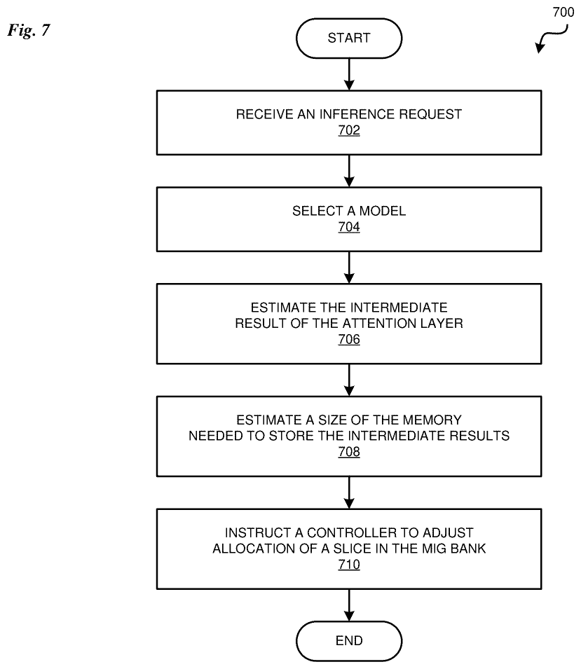

With reference to FIG. 7, this figure depicts a flowchart of an example process for MIGs-aware autoscaling in AI model service in accordance with an illustrative embodiment. Process 700 may be implemented using resource predictor 302 in FIG. 3.

The process receives a request to be processed by a transformer-type LLM (block 702). The process selects the model and obtains the model's characteristics, e.g., the number of nodes in an attention layer in the model (block 704). The process estimates the intermediate results of the attention layer—specifically a memory footprint or size of the intermediate results (block 706). The process estimates a size of the memory that is likely to be needed to store the intermediate results produced when the request of block 702 is processed using the model of block 704 (block 708). The process instructs a controller of a MIG to adjust a resource allocation of a slice in the MIG as a part of ensuring that the estimated amount of memory will be available for storing the intermediate results when the slice is used to process the request of block 702 on the model of block 704 (block 710). The process ends thereafter.

The following definitions and abbreviations are to be used for the interpretation of the claims and the specification. As used herein, the terms “comprises,” “comprising,” “includes,” “including,” “has,” “having,” “contains,” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
analyzing an inference request to determine a set of parameters of execution corresponding to the inference request;
computing, for a Large Language Model (LLM), a first amount of a computing resource that will be needed to produce and store the LLM output, the LLM output comprising a set of intermediate results produced while processing the inference request by executing the LLM using a set of multi-instance Graphical Processing Units (GPUs) (MIGs), a MIG in the set of MIGs comprising a set of slices of a corresponding GPU (set of MIG slices);
causing, by sending a set of instructions to a controller associated with the MIG, the controller to modify a second amount of the computing resource available to a MIG slice in the set of MIG slices; and
scheduling the inference request to execute using the first amount of computing resource at the MIG slice.

2. The computer-implemented method of claim 1, further comprising:
identifying an attention layer in the LLM, wherein the set of intermediate results is an output of the attention layer.

3. The computer-implemented method of claim 1, wherein the set of intermediate results is a set of Key-Value pairs at an intermediate layer in a neural network of the LLM.

4. The computer-implemented method of claim 1, further comprising:
analyzing, to extract a set of parameters of environment, a computing environment of the LLM, the computing environment comprising the MIGs; and
using, in the computing, at least a subset of the set of parameters of environment.

5. The computer-implemented method of claim 4, further comprising:
detecting a change in a parameter in the parameters of environment;
recomputing, using a changed value of the parameter in the parameters of environment, the first amount of the computing resource to form a third amount of the computing resource; and
causing, by sending a second set of instructions to the controller, the controller to modify the first amount of the computing resource available to the MIG slice to a third amount.

6. The computer-implemented method of claim 5, wherein the modification of the amount to the third amount occurs while the MIG slice is processing the inference request by suspending the processing of the inference request.

7. The computer-implemented method of claim 5, wherein the change in the parameter is a change in a performance of the LLM in the computing environment.

8. The computer-implemented method of claim 5, wherein the change in the parameter is a change in a number of active users using the computing environment.

9. The computer-implemented method of claim 5, wherein the change in the parameter is a change in rate of requests being directed at the LLM in the computing environment.

10. The computer-implemented method of claim 5, wherein the change in the parameter is a change in a utilization of at least one of the MIG slices.

11. The computer-implemented method of claim 1, wherein the computing resource is a memory available to the MIG slice in the set of MIG slices.

12. The computer-implemented method of claim 11, wherein the memory is one of a cache memory and a primary memory.

13. The computer-implemented method of claim 1, wherein the causing occurs while the MIG is processing another request.

14. The computer-implemented method of claim 1, wherein the set of instructions comprises an instruction to allocate the first amount by deallocating a third amount of computing resource from an existing amount of the computing resource already configured in the MIG slice.

15. The computer-implemented method of claim 14, wherein the deallocating occurs while the MIG is processing another request.

16. The computer-implemented method of claim 1, wherein the LLM is a transformer-type model.

17. A computer program product comprising:
One or more computer readable storage media; and
program instructions stored on the one or more storage media and configured to perform operations comprising:
analyzing an inference request to determine a set of parameters of execution corresponding to the inference request;
computing, for a Large Language Model (LLM), a first amount of a computing resource that will be needed to produce and store the LLM output, the LLM output comprising a set of intermediate results produced while processing the inference request by executing the LLM using a set of multi-instance Graphical Processing Units (GPUs) (MIGs), a MIG in the set of MIGs comprising a set of slices of a corresponding GPU (set of MIG slices);
causing, by sending a set of instructions to a controller associated with the MIG, the controller to modify a second amount of the computing resource available to a MIG slice in the set of MIG slices; and
scheduling the inference request to execute using the first amount of computing resource at the MIG slice.

18. The computer program product of claim 17, wherein the stored program instructions are stored in a computer readable storage device in a data processing system, and wherein the stored program instructions are transferred over a network from a remote data processing system.

19. The computer program product of claim 17, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

20. A computer system comprising a processor and one or more computer readable storage media, and program instructions collectively stored on the one or more computer readable storage media, the program instructions executable by the processor to cause the processor to perform operations comprising:
analyzing an inference request to determine a set of parameters of execution corresponding to the inference request;
computing, for a Large Language Model (LLM), a first amount of a computing resource that will be needed to produce and store the LLM output, the LLM output comprising a set of intermediate results produced while processing the inference request by executing the LLM using a set of multi-instance Graphical Processing Units (GPUs) (MIGs), a MIG in the set of MIGs comprising a set of slices of a corresponding GPU (set of MIG slices);
causing, by sending a set of instructions to a controller associated with the MIG, the controller to modify a second amount of the computing resource available to a MIG slice in the set of MIG slices; and
scheduling the inference request to execute using the first amount of computing resource at the MIG slice.
